(19) United States
(12) Patent Application Publication
(10) Pub. No.: US 2014/0326430 A1
(43) Pub. Date: Nov. 6, 2014

(54) VEHICLE WITH TRACTION MOTOR WITH PREEMPTIVE COOLING OF MOTOR FLUID CIRCUIT PRIOR TO COOLING OF BATTERY FLUID CIRCUIT

(71) Applicant: MAGNA E-CAR SYSTEMS OF AMERICA, INC., Auburn Hills, MI (US)

(72) Inventors: Neil Carpenter, Clarkston, MI (US); Guangning Gao, Rochester Hills, MI (US); Ibrahim Al-Keilani, Auburn Hills, MI (US)

(21) Appl. No.: 14/364,915

(22) PCT Filed: Dec. 11, 2012
(86) PCT No.: PCT/US2012/068882

§ 371 Date: Jun. 12, 2014

Related U.S. Application Data
(60) Provisional application No. 61/570,574, filed on Dec. 14, 2011.

(51) Int. Cl. B60H 1/00; B60W 10/30

(52) U.S. Cl. CPC B60H 1/00278; B60H 1/00764; B60H 1/00885; B60W 10/30; B60H 2001/00307; B60W 2510/246
USPC 165/41; 62/243; 165/294

(57) ABSTRACT

A thermal management system for an electric vehicle includes a controller that carries out a method of cooling a battery of the electric vehicle. The method includes: a) when charging the battery using an external electrical source but prior to the temperature of the battery reaching a selected temperature, cooling a motor of the electric vehicle by a selected amount by circulating fluid between the motor and a radiator of the electric vehicle, and b) after step a) cooling the battery of the electric vehicle by circulating fluid between the battery, the motor and the radiator while charging the battery using the external electrical source.

### CROSS-REFERENCE TO RELATED APPLICATIONS

This application claims the benefit of U.S. Patent Application No. 61/570,574, filed Dec. 14, 2011, which is hereby incorporated by reference in its entirety.

### FIELD OF THE INVENTION

The present disclosure relates to electric vehicles (ie. vehicles that are powered at least partly by an electric motor) and more particularly to battery electric vehicles with no internal combustion engine on board.

### BACKGROUND OF THE INVENTION

This section provides background information related to the present disclosure which is not necessarily prior art.

Electric vehicles offer the promise of powered transportation through the use of electric motors while producing few or no emissions. Some electric vehicles are powered by electric motors only and rely solely on the energy stored in an on-board battery pack. Other electric vehicles are hybrids, and include an internal combustion engine, which may, for example, be used to assist the electric motor in driving the wheels (a parallel hybrid), or which may, for example, be used solely to charge the on-board battery pack, thereby extending the operating range of the vehicle (a series hybrid). In some vehicles, there is a single, centrally-positioned electric motor that powers one or more of the vehicle wheels, and in other vehicles, one or more of the wheels have an electric motor positioned at each driven wheel.

While currently proposed and existing vehicles are advantageous in some respects over internal-combustion engine powered vehicles, there are problems that are associated with some electric vehicles. A particular problem is that their range is typically relatively short as compared to internal combustion engine-powered vehicles. This is particularly true for battery electric vehicles that are not equipped with range extender engines. A reason for this limitation is the weight and cost of the battery packs used to store energy for the operation of such vehicles. It would be beneficial to provide technology that improves the efficiency with which power is used in the operation of the vehicle, so as to improve the range of such vehicles.

### SUMMARY OF THE INVENTION

This section provides a general summary of the disclosure, and is not a comprehensive disclosure of its full scope or all of its features.

According to a first aspect of this disclosure, a thermal management system for an electric vehicle is disclosed. The electric vehicle includes a traction motor, a battery, and a passenger cabin. The thermal management system can include a motor circuit for cooling a motor circuit thermal load including the traction motor and a battery circuit for cooling a battery circuit thermal load including the battery. The motor circuit can include a radiator and a motor circuit pump. The battery circuit can include a battery circuit pump. A valve can be positioned to connect the motor circuit to the battery circuit. The valve can have a first position that allows fluid to flow between the motor circuit and the battery circuit and a second position that prevents fluid from flowing between the motor circuit and the battery circuit. A controller can be configured to position the valve in the second position and operate the motor circuit pump to preemptively cool the motor circuit thermal load and subsequently position the valve in the first position and operate the battery circuit pump to cool the battery circuit thermal load using the radiator.

The system can further include a motor circuit temperature sensor positioned to sense a temperature of fluid in the motor circuit. The controller can be configured to position the valve in the second position and operate the motor circuit pump according to at least the temperature sensed by the motor circuit temperature sensor when the battery is being charged.

The controller can be configured to position the valve in the second position and operate the motor circuit pump according to a state of charge of the battery.

The system can further include a battery circuit temperature sensor positioned to sense a temperature of fluid in the battery circuit. The controller can be configured to position the valve in the second position and operate the motor circuit pump according to the temperature sensed by the battery circuit temperature sensor.

The system can further include an ambient temperature sensor positioned to detect an ambient temperature. The controller can be configured to position the valve in the second position and operate the motor circuit pump according to the temperature sensed by the ambient temperature sensor.

The system can further include a battery circuit temperature sensor positioned to sense a temperature of fluid in the battery circuit. The controller can be configured to position the valve in the first position and operate the battery circuit pump according to the temperature sensed by the battery circuit temperature sensor.

The system can further include a radiator fan adjacent the radiator. The controller can be configured to operate the radiator fan when positioning the valve in the first position and operating the battery circuit pump to cool the battery circuit thermal load using the radiator.

The radiator can be the only radiator provided to the electric vehicle.

The battery circuit can further include a chiller. The system can further include a compressor connected to the chiller. The controller can be configured to not operate the compressor when positioning the valve in the first position and operating the battery circuit pump to cool the battery circuit thermal load using the radiator.

According to a second aspect of this disclosure, a thermal management system for an electric vehicle is disclosed. The electric vehicle includes a traction motor, a battery, and a passenger cabin. The thermal management system can include a motor circuit for cooling a motor circuit thermal load including the traction motor. The motor circuit can include a radiator and a motor circuit pump. A motor circuit temperature sensor can be positioned to sense a temperature of fluid in the motor circuit. The thermal management system can include battery circuit for cooling a battery circuit thermal load including the battery. The battery circuit can include a battery circuit pump. A battery circuit temperature sensor can be positioned to sense a temperature of fluid in the battery circuit. A valve can be positioned to connect the motor circuit to the battery circuit. The valve can have a first position that allows fluid to flow between the motor circuit and the battery circuit and a second position that prevents fluid from flowing between the motor circuit and the battery circuit. An ambient temperature sensor can be positioned to detect an ambient temperature. A controller can be configured to position the valve in the second position and operate the motor circuit pump to preemptively cool the motor circuit thermal load based on a high temperature sensed by the motor circuit temperature sensor, a state of charge of the battery during charging, the temperature sensed by the battery circuit temperature sensor, and the ambient temperature. The controller can be further configured to position the valve in the first position and operating the battery circuit pump to cool the battery circuit thermal load using the radiator after a temperature lower than the high temperature is sensed by the motor circuit temperature sensor.

The thermal management system can further include a radiator fan adjacent the radiator. The controller can be configured to operate the radiator fan when positioning the valve in the first position and operating the battery circuit pump to cool the battery circuit thermal load using the radiator.

The radiator can be the only radiator provided to the electric vehicle.

The battery circuit can further include a chiller. The system can further include a compressor connected to the chiller. The controller can be configured to not operate the compressor when positioning the valve in the first position and operating the battery circuit pump to cool the battery circuit thermal load using the radiator.

According to a third aspect of this disclosure, a method of cooling a battery of an electric vehicle is disclosed. The method includes, when charging the battery, cooling a motor of the electric vehicle by circulating fluid between the motor and a radiator of the electric vehicle. The method further includes, after cooling the motor and when charging the battery, cooling the battery of the electric vehicle by circulating fluid between the battery and the radiator.

The method can further include operating a radiator fan when cooling the motor and when cooling the battery.

The method can further include not operating a chiller compressor when cooling the battery.

The method can further include sensing a high temperature of the motor as a condition for cooling the motor and stopping to cool the motor after sensing a temperature of the motor lower than the high temperature and lower than a desired battery temperature of the battery.

The method can further include sensing a temperature of the battery as being above an amount below the desired battery temperature of the battery as a further condition for cooling the motor.

The method can further include sensing an ambient temperature as being lower than the desired battery temperature of the battery as a further condition for cooling the motor.

The method can further include determining a state of charge of the battery as being less than full charge as a further condition for cooling the motor.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

The present disclosure will now be described, by way of example only, with reference to the attached drawings, in which:

FIG. 1 is a perspective view of an electric vehicle that includes a thermal management system in accordance with an embodiment of the present disclosure;

FIG. 2 is a schematic illustration of a thermal management system for the electric vehicle;

FIG. 3 is a graph of the temperature of battery packs that are part of the electric vehicle shown in FIG. 1;

FIG. 4 is a lookup table that may be used by a controller of the thermal management system to determine when to enter a preemptive cooling mode of a motor circuit thermal load in advance of cooling a battery circuit thermal load, in accordance with another embodiment of the present invention;

FIG. 5 is a graph of showing a preemptive cooling mode of the thermal management system.

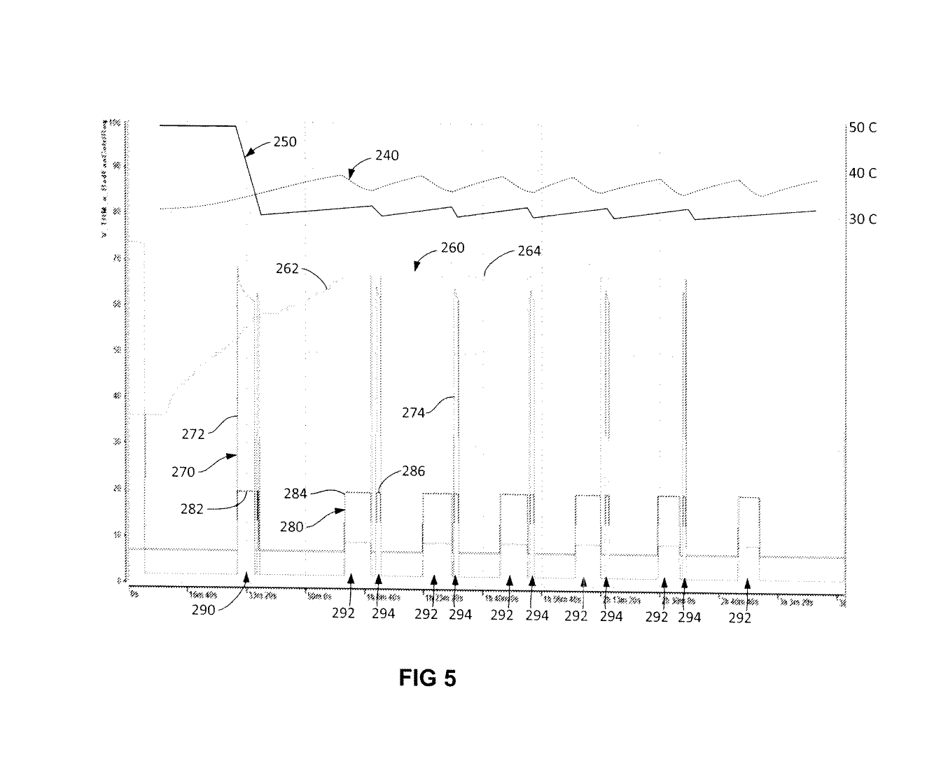

### DETAILED DESCRIPTION OF THE INVENTION

Example embodiments will now be described more fully with reference to the accompanying drawings. However, the example embodiments are only provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

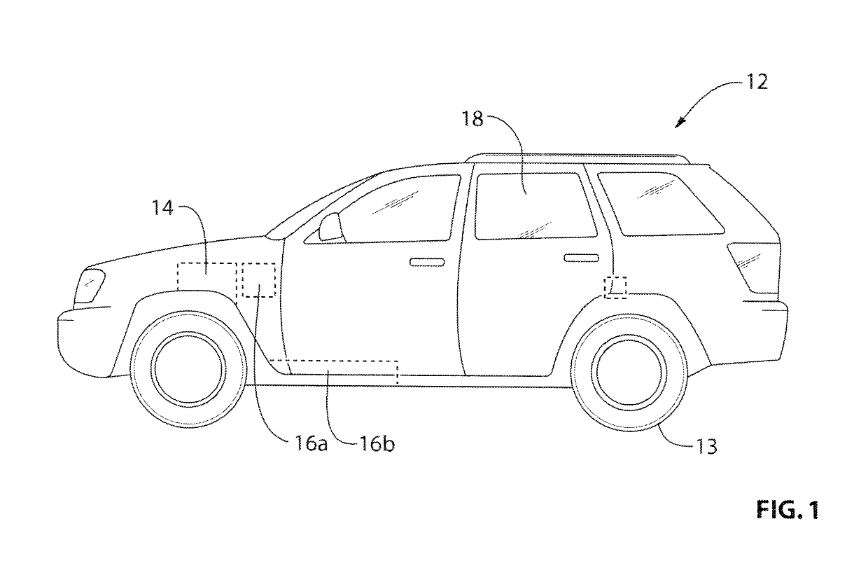

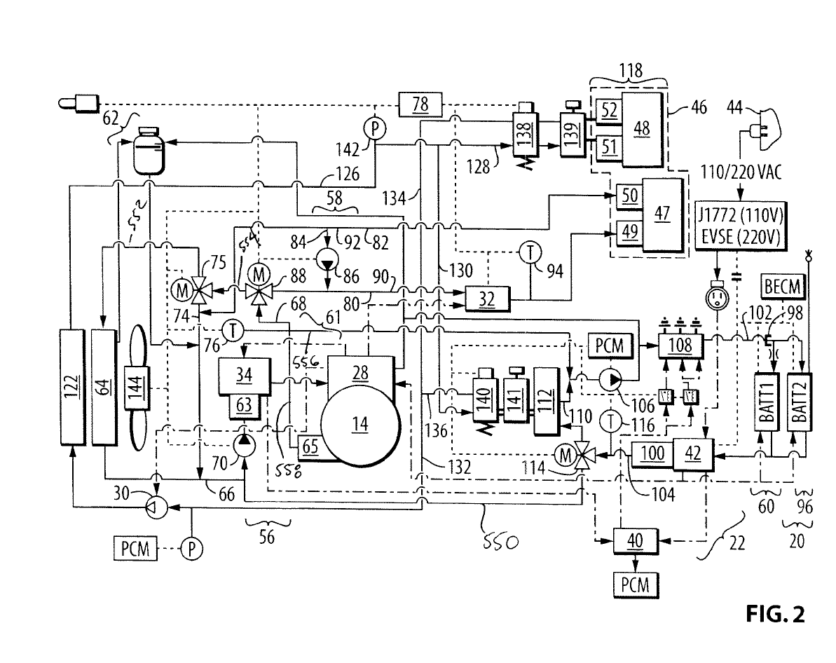

Reference is made to FIG. 2, which shows a schematic illustration of a thermal management system 10 for an electric vehicle 12 shown in FIG. 1. The electric vehicle 12 includes wheels 13, a traction motor 14 for driving the wheels 13, first and second battery packs 16a and 16b, a cabin 18, a high voltage electrical system 20 (FIG. 2) and a low voltage electrical system 22 (FIG. 2).

The motor 14 may have any suitable configuration for use in powering the electric vehicle 12. The motor 14 may be mounted in a motor compartment that is forward of the cabin 18 and that is generally in the same place an engine compartment is on a typical internal combustion powered vehicle. Referring to FIG. 2, the motor 14 generates heat during use and thus requires cooling. To this end, the motor 14 includes a motor coolant flow conduit for transporting coolant fluid about the motor 14 so as to maintain the motor within a suitable temperature range.

A transmission control system shown at 28 is part of the high voltage electrical system 20 and is provided for controlling the current flow to high voltage electrical loads within the vehicle 12, such as the motor 14, an air conditioning compressor 30, a heater 32 and a DC/DC converter 34. The transmission control system 28 generates heat during use and thus has a transmission control system coolant flow conduit associated therewith, for transporting coolant fluid about the transmission control system 28 so as to maintain the transmission control system 28 within a suitable temperature range. The transmission control system 28 may be positioned immediately upstream fluidically from the motor 14.

The DC/DC converter 34 receives current from the transmission control system 28 and converts it from high voltage to low voltage. The DC/DC converter 34 sends the low voltage current to a low voltage battery shown at 40, which is used to power low voltage loads in the vehicle 12. The low voltage battery 40 may operate on any suitable voltage, such as 12 V.

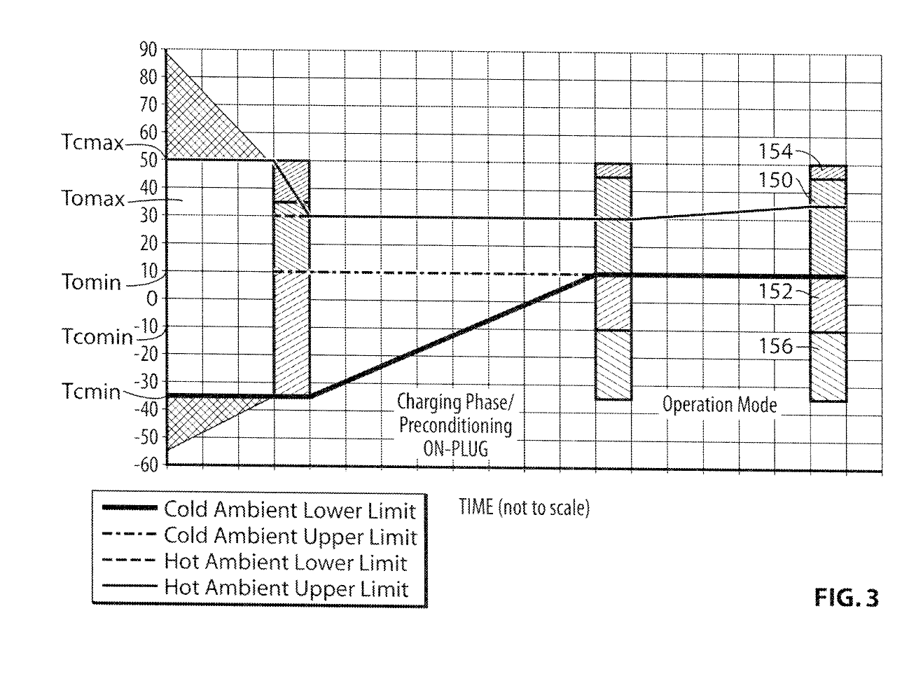

The battery packs 16a and 16b send power to the transmission control system 28 for use by the motor 14 and other high voltage loads and thus form part of the high voltage electrical system 20. The battery packs 16a and 16b may be any suitable types of battery packs. In an embodiment, the battery packs 16a and 16b are each made up of a plurality of lithium polymer cells. The battery packs 16a and 16b have a temperature range (shown in FIG. 3) in which they are preferably maintained so as to provide them with a relatively long operating life. While two battery packs 16a and 16b are shown, it is alternatively possible to have any suitable number of battery packs, such as one battery pack, or 3 or more battery packs depending on the packaging constraints of the vehicle 12.

A battery charge control module shown at 42 is provided and is configured to connect the vehicle 12 to an electrical source (eg. a 110V source, or a 220V source) shown at 44, and to send the current received from the electrical source 44 to any of several destinations, such as, the battery packs 16a and 16b, the transmission control system 28 and the low voltage battery 40. The battery charge control module 42 generates heat during use and thus requires cooling. To this end, the battery charge control module 42 includes a battery charge control module fluid flow conduit for transporting fluid about the battery charge control module 42 from a battery charge control module inlet 4 to a battery charge control module outlet 26 so as to maintain the battery charge control module 42 within a suitable temperature range.

An HVAC system 46 is provided for controlling the temperature of the cabin 18 (FIG. 1). The HVAC system 46 is configured to be capable of both cooling and heating the cabin 18. To achieve this, the HVAC system 46 may include one or more heat exchangers, such as a cabin heating heat exchanger 47 and a cabin cooling heat exchanger 48 (which may be referred to as evaporator 48). The cabin heating heat exchanger 47 has a heat exchange fluid inlet 49 and a heat exchange fluid outlet 50 and is used to heat an air flow that is passed into the cabin 18. The cabin cooling heat exchanger 48 includes a refrigerant inlet 51 and a refrigerant outlet 52, and is used to cool an air flow that is passed into the cabin 18.

The motor 14, the transmission control system 28, the DC/DC converter 34, the battery packs 16a and 16b, the battery charge control module 42 and the HVAC system 46 constitute thermal loads on the thermal management system 10.

The thermal management system 10 includes a motor circuit 56, a cabin heating circuit 58, a battery circuit 60 and a main cooling circuit 62. The motor circuit 56 is configured for cooling the traction motor 14, the transmission control system 28 and the DC/DC converter 34, which constitute a motor circuit thermal load 61, which has a motor circuit thermal load inlet 63 and a motor circuit thermal load outlet 65. The motor circuit 56 includes a radiator 64, a first motor circuit conduit 66 fluidically between the radiator 64 to the motor circuit thermal load inlet 63, a second motor circuit conduit 68 fluidically between the motor circuit thermal load outlet 65 and the radiator 64, and a motor circuit pump 70 positioned to pump heat exchange fluid through the motor circuit 56.

Additionally a third motor circuit conduit 74 may be provided fluidically between the second and first motor circuit conduits 68 and 66 so as to permit the flow of heat exchange fluid to bypass the radiator 64 when possible (eg. when the heat exchange fluid is below a selected threshold temperature). To control whether the flow of heat exchange fluid is directed through the radiator 64 or through the third motor circuit conduit 74, a radiator bypass valve 75 is provided and may be positioned in the second motor circuit conduit 68. The radiator bypass valve 75 is controllable so that in a first position it directs the flow of heat exchange fluid to the radiator 64 through the second motor circuit conduit 68 and in a second position it directs the flow of heat exchange fluid to the first motor circuit conduit 66 through the third motor circuit conduit 74, so as to bypass the radiator 64. Flow through the third motor circuit conduit 74 is easier than flow through the radiator 64 (ie. there is less of a pressure drop associated with flow through the third conduit than there is with flow through the radiator 64) and so bypassing the radiator 64 whenever possible, reduces the energy consumption of the pump 70. By reducing the energy consumed by components in the vehicle 12 (FIG. 1), the range of the vehicle can be extended, which is particularly advantageous in electric vehicles.

It will be noted that only a single radiator bypass valve 75 is provided for bypassing the radiator 64. When the radiator bypass valve 75 is in the first position, all of the heat exchange fluid flow is directed through the second conduit 68, through the radiator 64 and through the first conduit 66. There is no net flow through the third conduit 74 because there is no net flow into the third conduit. Conversely, when the radiator bypass valve 75 is in the second position, all of the heat exchange fluid flow is directed through the third conduit 74 and back to the first conduit 66. There is no net flow through the radiator 64 because there is no net flow into the radiator 64. Thus, using only a single valve (ie. the bypass valve 75) provides the capability of selectably bypassing the radiator 64, instead of using one valve at the junction of the second and third conduits 68 and 74 and another valve at the junction of the first and third conduits 66 and 74. As a result of using one valve (ie. valve 75) instead of two valves, the motor circuit 56 contains fewer components, thereby making it less expensive, simpler to make and to operate and more reliable. Furthermore by eliminating one valve, the energy required to move the heat exchange fluid through the motor circuit 56 is reduced, thereby reducing the energy consumed by the pump 70 and extending the range of the vehicle 12 (FIG. 1).

The pump 70 may be positioned anywhere suitable, such as in the first motor circuit conduit 66.

The elements that make up the motor circuit thermal load may be arranged in any suitable way. For example, the DC/DC converter 34 may be downstream from the pump 70 and upstream from the transmission control system 28, and the motor 14 may be downstream from the transmission control system 28. Thus, the inlet to the DC/DC converter 34 constitutes the thermal load inlet 63 and the motor outlet constitutes the thermal load outlet 65.

A motor circuit temperature sensor 76 is provided for determining the temperature of heat exchange fluid at a selected point in the motor circuit 56. As an example, the motor circuit temperature sensor 76 may be positioned downstream from all the thermal loads in the motor circuit 56, so as to record the highest temperature of the heat exchange fluid. Based on this temperature, a controller, shown at 78 can determine whether or not to position the radiator bypass valve 75 in a first position wherein the radiator bypass valve 75 transfers the flow of heat exchange fluid towards the radiator 64 and a second position wherein the radiator bypass valve 75 bypasses the radiator 64 and transfers the flow of heat exchange fluid through the third motor circuit conduit 74 back to the first motor circuit conduit 66.

The cabin heating circuit 58 is configured for providing heated heat exchange fluid to the HVAC system 46 and more specifically to the cabin heating heat exchanger 47, which constitutes the cabin heating circuit thermal load. The cabin heating circuit 58 includes a first cabin heating circuit conduit 80 fluidically between the second motor circuit conduit 68 and the cabin heating heat exchanger inlet 49 (which in the embodiment shown is the inlet to the cabin heating circuit thermal load), a second cabin heating circuit conduit 82 fluidically between the cabin heating circuit heat exchanger outlet 50 (which in the embodiment shown is the outlet from the cabin heating circuit thermal load) to the motor circuit 56. In the embodiment shown the second cabin heating circuit conduit 82 extends to the third motor circuit conduit 74. This is because the cabin heating heat exchanger 47 serves to cool the heat exchange fluid by some amount, so that the resulting cooled heat exchange fluid need not be passed through the radiator 64 in the motor circuit 56. By reducing the volume of heat exchange fluid that passes through the radiator 64, energy consumed by the pump 70 is reduced, thereby extending the range of the vehicle 12 (FIG. 1). In an alternative embodiment, the second cabin heating circuit conduit 82 may extend to the second motor circuit conduit 68 downstream so that the heat exchange fluid contained in the second cabin heating circuit conduit 82 passes through the radiator 64.

In some situations the heat exchange fluid will not be sufficiently hot to meet the demands of the HVAC system 46. For such situations, the heater 32 which may be referred to as the cabin heating circuit heater 32 is provided in the first cabin heating circuit conduit 80. The cabin heating circuit heater 32 may be any suitable type of heater, such as an electric heater that is one of the high voltage electrical components fed by the transmission control system 28.

A third cabin heating circuit conduit 84 may be provided between the second and first cabin heating circuit conduits 82 and 80. A cabin heating circuit pump 86 is provided in the third conduit 84. In some situations it will be desirable to circulate heat exchange fluid through the cabin heating circuit 58 and not to transfer the fluid back to the motor circuit 56. For example, when the fluid is being heated by the heater 32 it may be advantageous to not transfer the fluid back to the motor circuit 56 since the fluid in the motor circuit 56 is used solely for cooling the thermal load 61 and it is thus undesirable to introduce hot fluid into such a circuit. For the purpose of preventing fluid from being transferred from the cabin heating circuit 58 back to the motor circuit 56, a cabin heating circuit valve 88 is provided. In the embodiment shown, the cabin heating circuit valve 88 is positioned in the second motor circuit conduit 68 and is positionable in a first position wherein the valve 88 directs fluid flow towards the radiator 64 through the second motor circuit conduit 68, and a second position wherein the valve 88 directs fluid flow towards the cabin heater heat exchanger 47 through the first cabin heating circuit conduit 80.

When the cabin heating circuit valve 88 is in the second position, the pump 86 may operate at a selected, low, flow rate to prevent the fluid flow from short circuiting the cabin heating circuit by flowing up the third conduit 84.

It will be noted that separation of the fluid flow through the cabin heating circuit 58 and the motor circuit 56 is achieved using a single valve (ie. valve 88) which is positioned at the junction of the second motor circuit conduit 68 and the first cabin heating circuit conduit 80. When the valve 88 is positioned in the first position, fluid is directed towards the radiator 64. There is no net flow out of the cabin heating circuit 58 since there is no flow into the cabin heating circuit 58. When the valve 88 is positioned in the second position and the pump 86 is off, fluid is directed through the cabin heating circuit 58 and back into the motor circuit 56. When the valve 88 is positioned in the first position and the pump 86 is on, there is no net flow out of the second cabin heating circuit conduit 82 as noted above, however, the pump 86 generates a fluid circuit loop and drives fluid in a downstream portion 90 of the first cabin heating circuit conduit 80, through the cabin heating heat exchanger 47, and through an upstream portion 92 of the second cabin heating circuit conduit 82, whereupon the fluid is drawn back into the pump 86. Because this feature is provided using a single valve (ie. valve 88), as opposed to using one valve at the junction of the first cabin heating circuit conduit 80 and the motor circuit 56 and another valve at the junction of the second cabin heating circuit conduit 82 and the motor circuit 56, the thermal management system 10 is made simpler and less expensive, and it further saves energy consumption by having fewer valves in the system 10 so as to reduce the energy required by the pump 70 to pump liquid through such valves.

Additionally, the valve 88 combined with the pump 86 permit isolating heated fluid in the cabin heating circuit 58 from the fluid in the motor circuit 56, thereby preventing fluid that has been heated in the cabin heating circuit heater 32 from being sent to the radiator 64 to be cooled.

A cabin heating circuit temperature sensor 94 may be provided for determining the temperature of the fluid in the cabin heating circuit 58. The temperature sensor 94 may be positioned anywhere suitable, such as downstream from the cabin heating circuit heater 32. The temperature sensor 94 may communicate with the controller 78 so that the controller 78 can determine whether or not to carry out certain actions. For example, using the temperature sensed by the temperature sensor 94, the controller 78 can determine whether the heater 32 should be activated to meet the cabin heating demands of the HVAC system 46.

The battery circuit 60 is configured for controlling the temperature of the battery packs 16a and 16b and the battery charge control module 42, which together make up the battery circuit thermal load 96. A thermal load inlet is shown at 98 upstream from the battery packs 16a and 16b and a thermal load outlet is shown at 100 downstream from the battery charge control module 42. The battery packs 16a and 16b are in parallel in the battery circuit 60, which permits the fluid flow to each of the battery packs 16a and 16b to be selected individually so that each battery pack 16a or 16b receives as much fluid as necessary to achieve a selected temperature change. A valve for adjusting the flow of fluid that goes to each battery pack 16a and 16b during use of the thermal management system 10 may be provided, so that the fluid flow can be adjusted to meet the instantaneous demands of the battery packs 16a and 16b. After the fluid has passed through the battery packs 16a and 16b, the fluid is brought into a single conduit which passes through the battery charge control module 42. While the battery packs 16a and 16b are shown in parallel in the battery circuit 60, they could be provided in series in an alternative embodiment.

A first battery circuit conduit 102 extends between the second motor circuit conduit 68 and the battery circuit thermal load inlet 98. A second battery circuit conduit 104 extends between the thermal load outlet 100 and the first motor circuit conduit 66. A battery circuit pump 106 may be provided for pumping fluid through the battery circuit 60 in situations where the battery circuit 60 is isolated from the motor circuit 56. A battery circuit heater 108 is provided in the first conduit 102 for heating fluid upstream from the thermal load 96 in situations where the thermal load 96 requires it. The battery circuit heater 108 may operate on current from a low voltage current source, such as the low voltage battery 40. This is discussed in further detail further below.

A third battery circuit conduit 110 may be provided fluidically between the second and first battery circuit conduits 102 and 104 so as to permit the flow of heat exchange fluid in the battery circuit 60 to be isolated from the flow of heat exchange fluid in the motor circuit 56. A chiller 112 may be provided in the third conduit 110 for cooling fluid upstream from the thermal load 96 when needed.

A battery circuit valve 114 is provided in the second conduit 104 and is positionable in a first position wherein the flow of fluid is directed towards the first motor circuit conduit 66 and in a second position wherein the flow of fluid is directed into the third battery circuit conduit 110 towards the first battery circuit conduit 102.

It will be noted that the flow in the battery circuit 60 is isolated from the flow in the motor circuit 56 with only one valve (ie. valve 114). When the valve 114 is in the second position so as to direct fluid flow through the third conduit 110 into the first conduit 102, there is effectively no flow from the first motor circuit 56 through the first conduit 102 since the loop made up of the downstream portion of the first conduit 102, the thermal load 96, the second conduit 104 and the third conduit 110 is already full of fluid. By using only one valve (ie. valve 114) to isolate the battery circuit 60, the amount of energy consumed by the pump 106 to pump fluid around the battery circuit 60 is reduced relative to a similar arrangement using two valves. Additionally, by using only one valve the battery circuit is simpler (ie. it has fewer components), which reduces its cost and which could increase its reliability.

A battery circuit temperature sensor 116 is provided for sensing the temperature of the fluid in the battery circuit 60. The temperature sensor 116 may be positioned anywhere in the battery circuit 60, such as in the second conduit 104 downstream from the thermal load 96. The temperature from the temperature sensor 116 can be sent to the controller 78 to determine whether to have the valve 114 should be in the first or second position and whether any devices (eg. the chiller 112, the heater 108) need to be operated to adjust the temperature of the fluid in the first conduit 102.

The main cooling circuit 62 is provided for assisting in the thermal management of the thermal loads in the HVAC system 46 and the battery circuit 60. More particularly, the thermal load in the HVAC system 46 is shown at 118 and is made up of the cabin cooling heat exchanger 48 (ie. the evaporator 48).

The components of the main cooling circuit 62 that are involved in the cooling and management of the refrigerant flowing therein include the compressor 30 and a condenser 122. A first cooling circuit conduit 126 extends from the condenser 122 to a point wherein the conduit 126 divides into a first branch 128 which leads to the HVAC system 46 and a second branch 130 which leads to the battery circuit 60. A second cooling circuit conduit 132 has a first branch 134 that extends from the HVAC system 46 to a joining point and a second branch 136 that extends from the battery circuit 60 to the joining point. From the joining point, the second cooling circuit conduit 132 extends to the inlet to the compressor 30.

At the downstream end of the first branch 128 of the first conduit 126 is a flow control valve 138 which controls the flow of refrigerant into the cabin cooling exchanger 48. The upstream end of the first branch 134 of the second conduit 132 is connected to the refrigerant outlet from the heat exchanger 48. It will be understood that the valve 138 could be positioned at the upstream end of the first branch 134 of the second conduit 132 instead. The valve 138 is controlled by the controller 78 and is opened when refrigerant flow is needed through the heat exchanger 48.

At the downstream end of the second branch 130 of the first conduit 126 is a flow control valve 140 which controls the flow of refrigerant into the battery circuit chiller 112. The upstream end of the second branch 136 of the second conduit 132 is connected to the refrigerant outlet from the chiller 112. It will be understood that the valve 140 could be positioned at the upstream end of the second branch 136 of the second conduit 132 instead. The valve 140 is controlled by the controller 78 and is opened when refrigerant flow is needed through the chiller 112.

The valves 138 and 140 may be any suitable type of valves with any suitable type of actuator. For example, they may be solenoid actuated/spring return valves. Additionally thermostatic expansion valves shown at 139 and 141 may be provided downstream from the valves 138 and 140.

A refrigerant pressure sensor 142 may be provided anywhere suitable in the cooling circuit 62, such as on the first conduit 126 upstream from where it divides into the first and second branches 128 and 130. The pressure sensor 142 communicates pressure information from the cooling circuit 62 to the controller 78.

A fan shown at 144 is provided for blowing air on the radiator 64 and the condenser 122 to assist in cooling and condensing the heat exchange fluid and the refrigerant respectively. The fan 144 is controlled by the controller 78.

An expansion tank 124 is provided for removing gas that can accumulate in other components such as the radiator 64. The expansion tank 124 is preferably positioned at the highest elevation of any fluid-carrying components of the thermal management system. The expansion tank 124 may be used as a point of entry for heat exchange fluid into the thermal management system 10 (ie. the system 10 may be filled with the fluid via the expansion tank 124).

The controller 78 is described functionally as a single unit, however the controller 78 may be made up of a plurality of units that communicate with each other and which each control one or more components of the thermal management system 10, as well as other components optionally.

The logic used by the controller 78 to control the operation of the thermal management system 10 depends on which of several states the vehicle is in. The vehicle may be on-plug and off, which means that the vehicle itself is off (eg. the ignition key is out of its slot in the instrument panel) and is plugged into an external electrical source (eg. for recharging the battery packs 16a and 16b). The vehicle may be off-plug and off, which means that the vehicle itself is off and is not plugged into an external electrical source. The vehicle may be off-plug and on, which means that the vehicle itself is on and is not plugged into an external electrical source. The logic used by the controller 78 may be as follows:

The controller 78 attends to the cooling requirements of the thermal load 61 of the motor circuit 56 when the vehicle is off-plug and when the vehicle is on. The controller 78 determines a maximum permissible temperature for the heat exchange fluid and determines if the actual temperature of the heat exchange fluid exceeds it (based on the temperature sensed by the temperature sensor 76) by more than a selected amount (which is a calibrated value, and which could be 0 for example). If so, the controller operates the pump 70 to circulate the heat exchange fluid through the motor circuit 56. Initially when the vehicle enters the state of being off-plug and on, the controller 78 may default to a ‘cooling off’ mode wherein the pump 70 is not turned on, until it has determined and compared the aforementioned temperature values. In the event that the vehicle is in a fault state, the controller 78 may enter a motor circuit cooling fault mode. When the controller 78 exits the fault state, the controller 78 may pass to the ‘cooling off’ mode.

The controller 78 attends to the heating and cooling requirements of the cabin heating circuit 58 when the vehicle is on-plug and when the vehicle is off-plug and on. The controller 78 may have 3 cabin heating modes. The controller 78 determines if the requested cabin temperature from the climate control system in the cabin 18 exceeds the temperature sensed by a temperature sensor in the evaporator 48 that senses the actual temperature in the cabin 18 by a selected calibrated amount. If so, and if the vehicle is either off plug and on or on plug and there is sufficient power available from the electrical source, and if the controller 78 determines if the temperature sensed by the temperature sensor 76 is higher than the requested cabin temperature by a selected calibrated amount. If it is higher, then the controller 78 positions the cabin heating circuit valve 88 in its second position wherein flow is generated through the cabin heating circuit 58 from the motor circuit 56 and the controller 78 puts the cabin heating circuit heater 32 in the off position. These settings make up the first cabin heating mode. If the temperature sensed by the temperature sensor 76 is lower than the requested cabin temperature by a selected calibrated amount, then the controller 78 positions the cabin heating circuit valve 88 in the first position and turns on the pump 86 so that flow in the cabin heating circuit 58 is isolated from flow in the motor circuit 56, and the controller 78 additionally turns on the cabin heating circuit heater 32 to heat the flow in the cabin heating circuit 58. These settings make up the second cabin heating mode.

If the temperature sensed by the temperature sensor 76 is within a selected range of the requested temperature from the climate control system then the controller 78 positions the cabin heating circuit valve 88 in the second position so that flow in the cabin heating circuit 58 is not isolated from flow in the motor circuit 56, and the controller turns the heater 32 on. These settings make up the third cabin heating mode. The selected range may be the requested temperature from the climate control system minus the selected calibrated value, to the requested temperature from the climate control system plus the selected calibrated value.

The default state for the controller 78 when cabin heating is initially requested may be to use the first cabin heating mode.

The controller 78 may have one cabin cooling mode. The controller 78 determines if the actual temperature of the evaporator 48 is higher than the target temperature of the evaporator 48 by more than a calibrated amount. If so, and if the vehicle is either off plug and on or on plug and there is sufficient power available from the electrical source, then the controller 78 turns on the compressor 30 and moves the refrigerant flow control valve 138 to the open position so that refrigerant flows through the cabin cooling heat exchanger 48 to cool an air flow that is passed into the cabin 18.

The thermal management system 10 will enter a cabin heating and cabin cooling fault mode when the vehicle is in a fault state.

When the climate control system in the cabin 18 is set to a ‘defrost’ setting, the controller 78 will enter a defrost mode, and will return to whichever heating or cooling mode it was in once defrost is no longer needed.

The default mode for the controller 78 with respect to the cabin heating circuit 58 may be to have the cabin heating circuit valve 88 in the first position to direct flow towards the radiator, and to have the heater 32 off, the pump 86 off. The default mode for the controller 78 with respect to cooling the cabin 18 may to be to have the refrigerant flow control valve 138 in the closed position to prevent refrigerant flow through the cabin cooling heat exchanger 48, and to have the compressor 30 off.

The controller 78 attends to the heating and cooling requirements of the battery circuit 60 when the vehicle is on-plug and is off, and when the vehicle is off-plug and is on. The controller 78 may have three cooling modes for cooling the battery circuit thermal load 96. The controller 78 determines a desired battery pack temperature based on the particular situation, and determines if a first cooling condition is met, which is whether the desired battery pack temperature is lower than the actual battery pack temperature by a first selected calibrated amount.

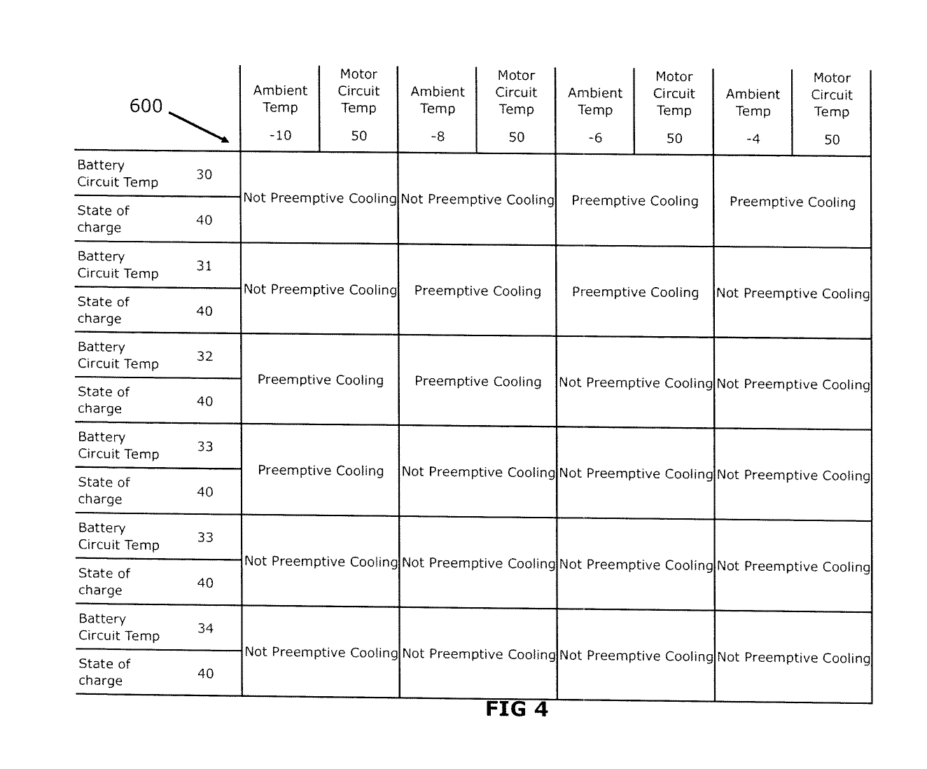

If the first cooling condition is met, the controller 78 determines which of the three cooling modes it will operate in by determining which, if any, of the following second and third cooling conditions are met. The three cooling modes are shown illustratively at the right side of FIG. 4, in which the temperature of the temperature sensor 76 is referenced on the vertical axis to determine which cooling mode to use.

The second condition is whether the temperature sensed by the temperature sensor 76 is lower than the desired battery pack temperature by at least a second selected calibrated amount DT2, which may, for example, be related to the expected temperature rise that would be incurred in the flow of fluid from the temperature sensor 76 to the battery circuit thermal load 96. If the second condition is met, then the controller 78 operates in a first battery circuit cooling mode, wherein it positions the battery circuit valve 114 in its first position wherein flow is generated through the battery circuit 60 from the motor circuit 56 and the controller 78 puts the refrigerant flow control valve 140 in the closed position preventing refrigerant flow through the chiller 112. The first battery circuit cooling mode thus uses the radiator 68 to cool the battery circuit thermal load 96 via the motor circuit 56.

The third cooling condition is whether the temperature sensed by the temperature sensor 76 is greater than the desired battery pack temperature by at least a third selected calibrated amount DT3, which may, for example, be related to the expected temperature drop associated with the chiller 112. If the third cooling condition is met, then the controller 78 operates in a second battery circuit cooling mode wherein it positions the battery circuit valve 114 in the second position and turns on the pump 106 so that flow in the battery circuit 60 is isolated from flow in the motor circuit 56, and the controller 78 additionally positions the flow control valve 140 in the open position so that refrigerant flows through the chiller 112 to cool the flow in the battery circuit 60.

If neither the second or third cooling conditions are met, (ie. if the temperature sensed by the temperature sensor 76 is greater than or equal to the desired battery pack temperature minus the second selected calibrated amount DT2 and the temperature sensed by the temperature sensor 76 is less than or equal to the desired battery pack temperature plus the third selected calibrated amount DT3, then the controller 78 operates in a third battery circuit cooling mode wherein it positions the battery circuit valve 114 in the first position so that flow in the battery circuit 60 is not isolated from flow in the motor circuit 56, and the controller 78 turns the chiller 112 on.

It will be understood that in any of the battery circuit cooling modes, the controller 78 turns the battery circuit heater 108 off.

The default state for the controller 78 when battery circuit thermal load cooling is initially requested may be to use the first battery circuit cooling mode.

Using the radiator 64 to cool the battery circuit thermal load 96 consumes less energy than using the chiller 112 for this purpose, and as such it is advantageous to use the radiator 64 to cool the battery circuit thermal load 96 when such cooling is needed. However, in the flow scenarios described above, the motor circuit thermal load 61, which includes powertrain components (e.g., the motor 14), is located upstream from the battery circuit thermal load 96 and as a result, coolant would flow from the motor circuit thermal load 61 to the battery circuit thermal load 96. In some situations it may be possible for the temperature of the motor circuit thermal load 61 to be above the acceptable temperature limit for the battery circuit thermal load 61 and as a result, it would not be desirable in such cases to send coolant from the motor circuit thermal load 61 to the battery circuit thermal load 96 where it could unacceptably elevate the temperature of the battery circuit thermal load. To address this problem, it has been found that it may be more energy-efficient to preemptively cool the motor circuit thermal load 61 using the radiator 64 to a sufficiently low temperature (lower than it would otherwise need to be) so that it would be safe to transport coolant from the motor circuit thermal load 61 through the battery circuit thermal load 96 and then cool the battery circuit thermal load 96 using the radiator 64, than it is to simply cool the battery circuit thermal load 96 alone using the chiller 112.

To achieve this, the controller 78 may carry out the following steps:
a) determine if the battery circuit thermal load 96 will require cooling at some point in time in the future;
b) determine if the ambient temperature is sufficiently low to permit the battery circuit thermal load 96 and the motor circuit thermal load 61 to be cooled sufficiently using the radiator;
c) determine if there is sufficient time to preemptively cool the motor circuit thermal load 61 to an acceptable temperature before the battery circuit thermal load 96 will require cooling;
d) if the battery circuit thermal load 96 will require cooling and if the ambient temperature is sufficiently low and if there is sufficient time to preemptively cool the motor circuit thermal load 61, then the motor circuit thermal load 61 is preemptively cooled at the appropriate time and then the battery circuit thermal load 96 is cooled using the radiator when needed, otherwise the chiller 112 is used to battery circuit thermal load 96 if needed.

Thus, the controller 78 may be considered to have a preemptive cooling mode for the motor circuit thermal load 61. The preemptive cooling mode can be used before the above-described first battery circuit cooling mode or a below-described fourth battery circuit cooling mode is used. The preemptive cooling mode and subsequent first or fourth battery circuit cooling mode can be used when the vehicle is on-plug and the battery circuit thermal load 96 heats up due to waste heat generated by the battery charge control module 42 and heat of other components of the high voltage electric system 20, which can include, to an extent, waste heat produced by the battery packs 16a, 16b themselves.

The controller 78 can run preemptive cooling of the motor circuit thermal load 61 until a temperature is reached that is conducive to cooling the battery packs 16a, 16b at a future time without using the chiller 112, and to maintaining the battery packs 16a, 16b within a selected temperature range (e.g. 36-38 degrees Celsius). Conditions that the controller 78 can use to determine whether preemptive cooling is to be applied can include a state of charge of the battery packs 16a, 16b, a temperature indicative of the temperature of the battery circuit thermal load 96 (i.e., output of temperature sensor 116), a temperature indicative of the temperature of the motor circuit thermal load 61 (i.e., output of temperature sensor 76), and an ambient temperature (e.g., output of an ambient temperature sensor 180).

In the description of the preemptive cooling mode and subsequent battery circuit cooling mode, the temperatures of the motor circuit thermal load 61 and battery circuit thermal load 96 are considered, for explanatory purposes, as equivalents to the respective temperatures of heat exchange fluid in the motor circuit 56 and battery circuit 60.

In the above described method, one can carry out step a) (i.e. determine whether the battery circuit thermal load 96 will require cooling at some point in the future) based on the current temperature of the battery circuit thermal load 96, the state of charge of the battery pack 16, and the relationship between the temperature of the battery circuit thermal load 96 and the length of time the battery packs 16 are being charged (at a given voltage level). Based on the relationship, one can determine the amount of temperature rise that the battery packs 16 will incur while being charged from any particular state of charge to a state of full charge. Thus, for any given state of charge there is a particular threshold temperature below which the battery packs 16 can reach full charge without exceeding their maximum allowable temperature, and above which the battery packs 16 will eventually exceed their maximum allowable temperature before reaching full charge. It will be understood that this threshold temperature will be different for different states of charge of the battery packs 16. For a given state of charge that is relatively lower, the battery packs 16 will incur a relatively greater amount of temperature rise to reach full charge and as a result, the threshold temperature below which the battery packs 16 will not exceed their maximum allowable temperature during the present charging cycle will be lower. For a given state of charge that is relatively higher, the battery packs 16 will incur a relatively lesser amount of temperature rise to reach full charge and as a result, the threshold temperature below which the battery packs 16 will not exceed their maximum allowable temperature during the present charging cycle will be higher. Thus for a particular state of charge and battery circuit thermal load temperature it can be determined by way of direct calculation or by use of a first lookup table (to reduce the computational burden on the controller 78) whether cooling of the bctl 96 will at some point be needed, or not needed.

When the battery circuit thermal load 96 (and in particular the battery packs 16) reaches an upper limit temperature (e.g. 38 degrees Celsius), the controller 78 will initiate cooling to bring the battery circuit thermal load 96 down to a lower target temperature (e.g. 36 degrees Celsius). Step b) above may be carried out by determining whether the ambient temperature is sufficiently low to permit use of the radiator 64 to bring the battery circuit thermal load 96 to the lower target temperature.

Step c) above may be carried out by comparing the amount of time required to preemptively cool the motor circuit thermal load 61 to an acceptable temperature (e.g. 30 degrees Celsius), with the amount of time that it will take for the battery circuit thermal load 96 to reach its upper limit temperature.

The amount of time required to preemptively cool the motor circuit thermal load 61 to an acceptable temperature depends on the current temperature of the motor circuit thermal load 61, the preemptive cooling target temperature for the motor circuit thermal load 61 (referred to above as the ‘acceptable temperature’, the ambient temperature and the fan speed. There may be many different strategies employed by the controller 78 to carry out this action. One strategy may be for the controller 78 to carry out the preemptive cooling step in a set period of time, regardless of the ambient temperature and regardless of the current mctl temperature. Thus, the controller 78 may be programmed to vary the fan speed to compensate for different mctl temperatures and ambient temperatures so that it takes a consistent amount of time to bring the mctl 61 to the acceptable temperature. Other strategies may alternatively be employed instead. For example, it could be that it be done as quickly as possible, by running the fan 122 at its highest possible speed regardless of ambient temperature and mctl temperature. Alternatively it could be done with the fan at some fixed low speed (e.g. 20% of maximum fan speed) which may be a speed where the fan 144 is particularly energy efficient, so as to reduce energy consumption associated with the preemptive cooling.

The amount of time that it will take for the battery circuit thermal load 96 to reach its upper limit temperature can be determined based on the current temperature for the bctl 96 and the upper limit temperature, and based on the relationship mentioned above regarding the amount of time the battery packs 16 are being charged and the temperature increase incurred as a result.

If the amount of time required to preemptively cool the mctl 61 is longer than the time it will take for the bctl 96 to reach its upper limit temperature, then preemptive cooling will not be possible for the present charge cycle for the battery packs 16. While the preemptive cooling inherently means that some energy is being expended to cool the mctl 61 with the expectation that the bctl 96 will require cooling at a point in the future, it is advantageous to delay the cooling of the mctl 61 as long as possible so as to avoid as much as possible a scenario wherein the cooling of the mctl 61 is wasted because the vehicle 12 was taken off-plug and driven prior to the bctl 96 needing any cooling. Delaying it as long as possible is also advantageous so that as much passive cooling of the mctl 61 as possible can take place prior to the preemptive cooling so as to reduce the amount of energy that needs to be expended in carrying out the preemptive cooling. It is therefore desirable to initiate preemptive cooling only when the determined amount of time required for the bctl 96 to reach the maximum allowable temperature is approximately the same as, but slightly longer (to account for unknowns) than the determined amount of time needed to complete the preemptive cooling of the mctl 61.

Instead of calculating the times required for preemptive cooling of the mctl 61 and for the bctl 96 to reach the maximum allowable temperature, and comparing them to see whether they are sufficiently close, it may be possible to use a lookup table that has as its inputs the bctl, mctl and ambient temperatures, and fan speed and/or whatever other data are needed so as to reduce the computational load on the controller 78. The output of the lookup table would result in a go/no-go status for carrying out step d) (i.e. initiating preemptive cooling) assuming the determinations made in steps a) and b) also resulted in a decision that preemptive cooling is possible and will eventually be needed. By adjusting the combinations of inputs to the lookup table that would initiate the execution of step d), one can control how far in advance the preemptive cooling of the mctl 61 is completed before the bctl 96 needs to be cooled.

It will be noted that, while separate lookup tables may be used for the determinations made in steps a), b) and c), it is possible instead to use one single lookup table that takes into account all of the inputs and outputs a go/no-go decision regarding step d). The lookup table may be used in a repeating cycle at some fixed time interval (e.g. every second), or it may be used every time the controller 78 senses a change in one of the input values, or according to any other suitable strategy. An example of a lookup table is shown in FIG. 4 at 600.

To carry out step d) above (i.e. to preemptively cool the mctl 61), the controller 78 positions the radiator bypass valve 75 so as to connect conduits 554 and 552, positions the valve 88 to connect conduits 554 and 68 together, positions the battery circuit valve 114 in its second position that isolates the battery circuit 60 from the motor circuit 56, and operates the motor circuit pump 70. Accordingly, heat exchange fluid circulates through the motor circuit thermal load 61 to cool the motor circuit thermal load 61 and through the radiator 64 to dump the heat from the coolant. As noted above, the radiator fan 144 can further be operated at a constant speed or at a variable speed to aid cooling of the motor circuit thermal load 61.

The preemptive cooling of the mctl 61 is stopped based on the temperature sensed by the temperature sensor 76 reaching the above-mentioned ‘acceptable temperature’, or alternatively referred to as the motor circuit thermal load target temperature.

After the preemptive cooling is completed (i.e. after step d) above is completed), the controller 78 can cool the battery circuit thermal load 96 in any suitable way. For example, in an embodiment the controller 78 operates the battery circuit pump 106 at a selected speed (e.g., 67% of full speed), positions the radiator bypass valve 75 so as to connect conduits 554 and 552, positions the valve 88 to connect conduits 554 and 68 together, positions the battery circuit valve 114 in its second position that isolates the battery circuit 60 from the motor circuit 56, and operates the motor circuit pump 70, and controls the motor circuit pump 70 to be off. Accordingly, heat exchange fluid flows in a loop that is backwards through the radiator 64 from the flow direction arrows shown in FIG. 2. That is, flow is from the pump 106, through the conduits 102 and 104, through valve 114 and through conduit 550. At that point a first portion of the coolant flow passes through conduit 66, backwards through the radiator 64, through conduit 552, valve 75, conduit 554, valve 88, conduit 68, conduit 556 and back to the pump 106. A second portion of the flow passes through pump 70 (even though the pump 70 is off at that moment), through the motor circuit thermal load 61, through a portion of conduit 68 (shown at 558) and into conduit 556 where it joins with the first portion of the coolant flow back to the pump 106. Where the coolant flow divides at the downstream end of conduit 550, the proportions of coolant flow that enter conduit 66 vs. the pump 70 may be about 75%/25% respectively, and depend on the respective pressure drops associated with the two flow paths. Even though only a portion (e.g. 75%) of the coolant flow is passing through the radiator 64 at any time, some heat is being extracted from the coolant. Because the motor circuit thermal load 61 has been cooled preemptively, the motor circuit thermal load 61 is not likely to heat the 25% of the coolant flowing therethrough sufficiently to generate a potentially damaging temperature spike in the battery circuit thermal load 96.

The speed for the battery circuit pump 106 may be selected based on any suitable criteria and strategy.

In a numerical example, after being operated, the vehicle 12 is put on-plug to charge the battery packs 16a, 16b. The temperature sensed by the motor circuit temperature sensor 76 is 48 degrees Celsius, the temperature sensed by the battery circuit temperature sensor 116 is 30 degrees Celsius, and the temperature sensed by the ambient temperature sensor 180 is 25 degrees Celsius. Since the vehicle is on-plug, the temperature sensed by the battery circuit temperature sensor 116 will continue to rise as the batteries are charged, but the temperature sensed by the motor circuit temperature sensor 76 will stay about the same for a time (or decrease slightly) due to the thermal mass of the motor circuit thermal load 61. The controller 78 determines that the preemptive cooling mode is to be entered. The radiator fan 144 and motor circuit pump 70 are run as described above until the temperature sensed by the motor circuit temperature sensor 76 is 30 degrees Celsius. Then, shortly after the temperature sensor 76 reads 30 degrees Celsius, the temperature sensor 116 reads 38 degrees Celsius and the controller 78 enters the fourth cooling mode to reduce the temperature sensed by the temperature sensor 116 to 36 degrees Celsius. When the sensor 116 reports 36 degrees Celsius or less, the fourth cooling mode is stopped.

FIG. 6 shows two graphs in relation to time, that illustrate the numerical example outlined above. Initially, the battery circuit temperature sensor 116, as indicated by the curve 240, reports 30 degrees Celsius and the motor circuit temperature sensor 76, as indicated by the curve 250, reports 48 degrees Celsius. The curves 240, 250 reference the temperature scale on the right that ranges from 30 to 50 degrees Celsius.

A curve 260 represents the speed or duty cycle of the battery circuit pump 106. The battery circuit pump 106 starts at about 36% and ramps up to about 67% of full speed, after the vehicle 12 is plugged in and as the battery packs 16a, 16b draw charge, as indicated at 262. The battery circuit pump 106 speed is based on a flow request from the controller 78 based on the temperature of the battery charge control module 42 (FIG. 2). Thus, the curve 260 indirectly represents the heating of the battery circuit thermal load 96. During this period, however, the valve 114 isolates the battery circuit 60 from the motor circuit 56. However, the battery circuit pump flow is useful to maintain a relatively even temperature distribution across the battery packs 16, and to eliminate hot spots in the various elements that make up the bctl 96.

A curve 270 represents the speed or duty cycle of the motor circuit pump 70. A value of at least 10% is required to turn the pump 70 on. Thus any value of less than that indicates that the pump 70 is off.

A curve 280 represents operation of the radiator fan 144, which, when the vehicle 12 is on-plug, is controlled to run at either 20% or at less than 10%, which means that it is off.

As the battery packs 16a, 16b charge and the battery circuit thermal load 96 warms, the temperature sensed by the battery circuit temperature sensor 116 warms to a point (i.e., 34 degrees Celsius) which causes the controller 78 to command commencement of the preemptive cooling mode. The execution of this cooling mode is shown at 290. In this mode, the controller 78 operates the motor circuit pump 70 at an average of about 63%, shown by curve portion 272, and operates the radiator fan at 20%, shown by curve portion 282. As the motor circuit pump 70 speed is a function of the output of the motor circuit temperature sensor 76, the drop of curve 250 is reflected by a drop in curve 270. It will be noted that in this cooling mode 290, the valve 114 continues to isolate the battery circuit 60 from the motor circuit 56. As a result, it can be seen that, since the motor circuit 56 is being preemptively cooled, there is little to no effect on the increasing temperature sensed by the battery circuit temperature sensor 116, as shown by curve 240. However, during the preemptive cooling mode the temperature at the motor circuit 56 is steadily cooled, as shown by the steep drop in temperature shown in curve 250.

After several minutes, the mctl 61 reaches its target temperature of 30 degrees Celsius and so the controller 78 ends the preemptive cooling mode, and shuts off the pump 70 and the radiator fan 144. At this point the batteries packs 16 have not yet reached their maximum allowable temperature of 38 degrees Celsius and so the controller 78 does not yet enter a battery cooling mode.

When the battery circuit temperature sensor 116 reads a temperature of 38 degrees Celsius, the controller 78 enters a battery circuit cooling mode. The operation in this mode is shown at 292. When in this mode, the valves 75, 88, 114 are positioned as described above to connect the battery circuit 60 to the motor circuit 56, the radiator fan 144 is operated at 20%, and the motor circuit pump 70 is off (shown by the curve 270 at less than 10%). Accordingly, it can be seen that the temperature sensed by the battery circuit temperature sensor 116 drops and the speed of the battery circuit pump 106 remains at a steady 67%, at plateau 264.

After several minutes, the battery circuit temperature sensor 116 reports about 36 degrees Celsius, which prompts the controller 78 to exit the battery circuit cooling mode, thereby ending the ending a first battery cooling cycle.

While the bctl 96 was being cooled however, a reduced flow of coolant was passing through the mctl 61, as described above. As a result, at some point in time, equalization of residual heat in the motor 14 occurs and the temperature sensed by the motor circuit temperature sensor 76 rises enough (e.g., to 32 degrees Celsius) to require another preemptive cooling mode cycle for the mctl 61. Accordingly, at 294, the controller carries out another preemptive cooling mode cycle. As the bulk of the heat has already been removed from the motor circuit thermal load 61 by the initial preemptive cooling mode cycle 290, preemptive cooling mode cycle 294 is a maintenance cycle that is shorter than the initial preemptive cooling mode cycle 290. Optionally, when residual heat in the motor 14 is expected but not necessarily detectable, a fixed-duration preemptive cooling mode cycle 294 is commanded after a battery circuit cooling cycle 292, independent of the temperature sensed by the motor circuit temperature sensor 76.

Four subsequent battery circuit cooling cycles 292 and preemptive cooling mode cycles 294 are shown, followed by a final battery circuit cooling cycle 292. The final battery circuit cooling cycle 292, as well as subsequent battery circuit cooling cycles (not shown), may not be followed by a maintenance preemptive cooling mode cycle 294 because the motor 14 temperature may have equalized to a degree that no longer influences the temperature sensed by the motor circuit temperature sensor 76 enough to prompt the controller 78 to command a maintenance preemptive cooling mode cycle 294.

Numerically, the total energy cost for the above example can be calculated as follows. For each preemptive cooling cycle, operating the motor circuit pump 70 at about 63% (at about 12 watts, W) for about 11 minutes total costs about 2 watt-hours, Wh, and operating the radiator fan 144 at 20% (38 W) for about the same 11 minutes costs about 7 Wh. Therefore, the preemptive cooling cycles, both initial and maintenance, cost about 9 Wh. For the battery circuit cooling cycles, operating the radiator fan 144 at 20% (38 W) for about 46 minutes total costs about 29 Wh and operating the battery circuit pump 106 at 67% (28 W) for about the same 46 minutes costs about 22 Wh. Therefore, the battery circuit cooling cycles cost about 51 Wh. At other times, when only the battery circuit pump 106 operates, there are about 55 minutes where the battery circuit pump 106 ramps up from 36% to 67%, at an average of about 50% (14 W), that cost 13 Wh as well as about 94 minutes operating at 67% (28 W), between cooling cycles already accounted, that cost 44 Wh, bringing the total to 57 Wh. Thus, the total energy cost for the above example is 117 Wh.

In a typical charging scenario, such as a post-UDDS (urban dynamometer driving schedule) charge or post-highway charge, using the chiller 112 with the compressor 30 operating at 1600 W, the total energy cost may be about 650 Wh. Accordingly, the lower 117 Wh cost of the preemptive cooling mode and subsequent fourth battery circuit cooling mode may translate into a savings of 2 MPGe (miles per gallon gasoline equivalent) in some circumstances.

The preemptive cooling mode and subsequent fourth cooling mode are particularly suited for a vehicle 12 that has only a single radiator 64. Because a single radiator 64 can be used to cool each of the motor circuit 56 and the battery circuit 60 as described above, the vehicle 12 does not require an additional radiator and may therefore be advantageously cheaper, lighter, and more efficient to operate.

The controller 78 may have three battery circuit heating modes. The controller 78 determines a desired battery circuit thermal load temperature based on the particular situation, and determines whether a first heating condition is met, which is whether the desired battery pack temperature is higher than the actual battery pack temperature by a first selected calibrated amount. If the first heating condition is met, the controller 78 determines which of the three heating modes it will operate in by determining which, if any, of the following second and third heating conditions are met. The second heating condition is whether the temperature sensed by the temperature sensor 76 is higher than the desired battery pack temperature by a second selected calibrated amount that may, for example, be related to the expected temperature drop of the fluid as it flows from the temperature sensor 76 to the battery circuit thermal load 96. If the second condition is met, then the controller 78 operates in a first battery circuit heating mode, wherein it positions the battery circuit valve 114 in its first position wherein flow is generated through the battery circuit 60 from the motor circuit 56 and the controller 78 turns the battery circuit heater 32 off.

The third heating condition is whether the temperature sensed by the temperature sensor 76 is lower than the desired battery pack temperature by at least a third selected calibrated amount, which may, for example, be related to the expected temperature rise associated with the battery circuit heater 108. If this third heating condition is met, then the controller 78 operates in a second battery circuit heating mode wherein it positions the battery circuit valve 114 in the second position and turns on the pump 106 so that flow in the battery circuit 60 is isolated from flow in the motor circuit 56, and the controller 78 additionally turns on the battery circuit heater 108 to heat the flow in the battery circuit 60.

If neither the second or third conditions are met, (ie. if the temperature sensed by the temperature sensor 76 is less than or equal to the desired battery pack temperature plus the second selected calibrated amount and the temperature sensed by the temperature sensor 76 is greater than or equal to the desired battery pack temperature minus the third selected calibrated amount, then the controller 78 operates in a third battery circuit heating mode wherein it positions the battery circuit valve 114 in the first position so that flow in the battery circuit 60 is not isolated from flow in the motor circuit 56, and the controller 78 turns the battery circuit heater 108 on.

The default state for the controller 78 when battery circuit thermal load heating is initially requested may be to use the first battery circuit heating mode.

The thermal management system 10 will enter a battery circuit heating and cooling fault mode when the vehicle is in a fault state.

When the vehicle is off-plug, the controller 78 heats the battery circuit thermal load 96 using only the first battery circuit heating mode.

The default state for the controller 78 when the vehicle is turned on is to position the battery circuit valve 114 in the first position so as to not generate fluid flow through the battery circuit 60.

The controller 78 may operate using several other rules in addition to the above. For example the controller 78 may position the radiator bypass valve 75 in the first position to direct fluid flow through the radiator 64 if the temperature of the fluid sensed at sensor 76 is greater than the maximum acceptable temperature for the fluid plus a selected calibrated value and the cabin heating circuit valve 88 is in the first position and the battery circuit valve 114 is in the first position.

The controller 78 may also position the radiator bypass valve 75 in the first position to direct fluid flow through the radiator 64 if the temperature of the fluid sensed at sensor 76 has risen to be close to the maximum acceptable temperature for the fluid plus a selected calibrated value and the cabin heating circuit valve 88 is in the second position and the battery circuit valve 114 is in the second position.

In the event of an emergency battery shutdown, the controller 78 will shut off the compressor 30 and will turn on the cabin heating circuit heater 32 so as to bleed any residual voltage.

The temperature of the battery packs 16a and 16b may be maintained above their minimum required temperatures by the controller 78 through control of the refrigerant flow control valve 140 to the chiller 112. The temperature of the evaporator may be maintained above a selected temperature which is a target temperature minus a calibrated value, through opening and closing of the refrigerant flow control valve 138. The speed of the compressor 30 will be adjusted based on the state of the flow control valve 140 and of the flow control valve 138.

The controller 78 is programmed with the following high level objectives and strategies using the above described modes. The high level objectives include:

A. control the components related to heating and cooling of the battery circuit thermal load 96 to maintain the battery packs 16a and 16b and the battery charge control module 42 within the optimum temperature range during charging and vehicle operation;

B. maintain the motor 14, the transmission control system 28 and the DC/DC converter 34 at their optimum temperature ranges;

C. control the components related to heating and cooling the cabin 18 based on input from the climate control system; and

D. operate with a goal of maximizing vehicle range while meeting vehicle system requirements.

The controller 78 uses the following high level strategy on-plug:

When the vehicle is on-plug and is off, the controller 78 pre-conditions the battery packs 16a and 16b if required. Pre-conditioning entails bringing the battery packs 16a and 16b into a temperature range wherein the battery packs 16a and 16b are able to charge more quickly.

The controller 78 determines the amount of power available from the electrical source for temperature control of the battery packs 16a and 16b, which is used to determine the maximum permitted compressor speed, maximum fan speed or the battery pack heating requirements depending on whether the battery packs 16a and 16b require cooling or heating. A calibratible hysteresis band will enable the battery pack temperature control to occur in a cyclic manner if the battery pack temperatures go outside of the selected limits (which are shown in FIG. 3). If sufficient power is available from the electrical source, the battery packs 16a and 16b may be charged while simultaneously being conditioned (ie. while simultaneously being cooled or heated to remain within their selected temperature range). If the battery packs 16a and 16b reach their fully charged state, battery pack conditioning may continue, so as to bring the battery packs 16a and 16b to their selected temperature range for efficient operation.

When the vehicle is on-plug the battery circuit heater 108 may be used to bring the battery packs 16a and 16b up to a selected temperature range, as noted above. In one of the heating modes described above for the battery circuit 60, the battery circuit valve 114 is in the second position so that the flow in the battery circuit 60 is isolated from the flow in the motor circuit 56, and therefore the battery circuit heater 108 only has to heat the fluid in the battery circuit 60.

The cabin may be pre-conditioned (ie. heated or cooled while the vehicle is off) when the vehicle is on-plug and the state of charge of the battery packs 16a and 16b is greater than a selected value.

If the vehicle is started while on-plug, the controller 78 may continue to condition the battery packs 16a and 16b, to cool the motor circuit thermal load 61 and use of the HVAC system 46 for both heating and cooling the cabin 18 may be carried out.

When the vehicle is off-plug, battery pack heating may be achieved solely by using the heat in the fluid from the motor circuit (ie. without the need to activate the battery circuit heater 108). Thus, while the vehicle is off-plug and on and the battery packs 16a and 16b require heating, the battery circuit valve 114 may be in the first position so that the battery circuit 60 is not isolated from the motor circuit 56. Some flow may pass through the third battery circuit conduit 110 for flow balancing purposes, however the refrigerant flow to the chiller 112 is prevented while the battery packs 16a and 16b require heating. By using low-voltage battery circuit heaters instead of high-voltage heaters for the heaters 108, a weight-savings is achieved which thereby extends the range of the vehicle.

When the vehicle is off-plug, battery pack cooling may be achieved by isolating the battery circuit 60 from the motor circuit 56 by moving the battery circuit valve 114 to the second position and by opening the flow of refrigerant to the chiller 112 by moving the flow control valve 140 to its open position, and by running the compressor 30, as described above in one of the three cooling modes for the battery circuit 60.

It will be noted that the battery packs 16a and 16b may sometimes reach different temperatures during charging or vehicle operation. The controller 78 may at certain times request isolation of the battery circuit 60 from the motor circuit 56 and may operate the battery circuit pump 106 without operating the heater 108 or permitting refrigerant flow to the chiller 112. This will simply circulate fluid around the battery circuit 60 thereby balancing the temperatures between the battery packs 16a and 16b.

Reference is made to FIG. 3, which shows a graph of battery pack temperature vs. time to highlight several of the rules which the controller 78 (FIG. 2) follows. In situations where the vehicle is on-plug and the battery packs 16a and 16b are below a selected minimum charging temperature Tcmin (FIG. 3), the controller 78 will heat the battery packs 16a and 16b prior to charging them. Once the battery packs 16a and 16b reach the minimum charging temperature Tcmin, some of the power from the electrical source may be used to charge the battery packs 16a and 16b, and some of the power from the electrical source may continue to be used to heat them. When the battery packs 16a and 16b reach a minimum charge only temperature Tcomin, the controller 78 may stop using power from the electrical source to heat the battery packs 16a and 16b and may thus use all the power from the electrical source to charge them. Tcmin may be, for example, −35 degrees Celsius and Tcomin may be, for example, −10 degrees Celsius.

While charging, the controller 78 may precondition the battery packs 16a and 16b for operation of the vehicle. Thus, the controller 78 may bring the battery packs 16a and 16b to a desired minimum operating temperature Tomin while on-plug and preferably during charging.

In situations where the vehicle is on-plug and the battery packs 16a and 16b are above a selected maximum charging temperature Tcmax, the controller 78 will cool the battery packs 16a and 16b prior to charging them. Once the battery packs 16a and 16b come down to the maximum charging temperature Tcmax power from the electrical source may be used to charge them, while some power may be required to operate the compressor 30 and other components in order to maintain the temperatures of the battery packs 16a and 16b below the temperature Tcmax. Tcmax may be, for example, 30 degrees Celsius.

The battery packs 16a and 16b may have a maximum operating temperature Tomax that is the same or higher than the maximum charging temperature Tcmax. As such, when the battery packs 16a and 16b are cooled sufficiently for charging, they are already pre-conditioned for operation. In situations where the maximum operating temperature Tomax is higher than the maximum charging temperature Tcmax, the temperatures of the battery packs 16a and 16b may be permitted during operation after charging to rise from the temperature Tcmax until they reach the temperature Tomax.

The maximum and minimum operating temperatures Tomax and Tomin define a preferred operating range for the battery packs 16a and 16b. In situations where the battery packs 16a and 16b are below minimum operating temperature or above their maximum operating temperature, the vehicle may still be used to some degree. Within selected first ranges shown at 150 and 152 (based on the nature of the battery packs 16a and 16b) above and below the preferred operating range the vehicle may still be driven, but the power available will be somewhat limited. Within selected second ranges shown at 154 and 156 above and below the selected first ranges 150 and 152, the vehicle may still be driven in a limp home mode, but the power available will be more severely limited. Above and below the selected second ranges, the battery packs 16a and 16b cannot be used. The lower first range 150 may be between about 10 degrees Celsius and about −10 degrees Celsius and the upper first range 152 may be between about 35 degrees Celsius and about 45 degrees Celsius. The lower second range 154 may be between about −10 degrees Celsius and about −35 degrees Celsius. The upper second range may be between about 45 degrees Celsius and about 50 degrees Celsius.

It will be noted that the pumps 70, 86 and 106 are variable flow rate pumps. In this way they can be used to adjust the flow rates of the heat exchange fluid through the motor circuit 56, the cabin heating circuit 58 and the battery circuit 60. By controlling the flow rate generated by the pumps 70, 86 and 106, the amount of energy expended by the thermal management system 10 can be adjusted in relation to the level of criticality of the need to change the temperature in one or more of the thermal loads.

Additionally, the compressor 30 is also capable of variable speed control so as to meet the variable demands of the HVAC system 46 and the battery circuit 60.

Throughout this disclosure, the controller 78 is referred to as turning on devices (eg. the battery circuit heater 108, the chiller 112), turning off devices, or moving devices (eg. valve 88) between a first position and a second position. It will be noted that, in some situations, the device will already be in the position or the state desired by the controller 78, and so the controller 78 will not have to actually carry out any action on the device. For example, it may occur that the controller 78 determines that the chiller heater 108 needs to be turned on. However, the heater 108 may at that moment already be on based on a prior decision by the controller 78. In such a scenario, the controller 78 obviously does not actually ‘turn on’ the heater 108, even though such language is used throughout this disclosure. For the purposes of this disclosure and claims, the concepts of turning on, turning off and moving devices from one position to another are intended to include situations wherein the device is already in the state or position desired and no actual action is carried out by the controller on the device.

While the above description constitutes a plurality of embodiments of the present disclosure, it will be appreciated that the present disclosure is susceptible to further modification and change without departing from the fair meaning of the accompanying claims.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A thermal management system for an electric vehicle, the electric vehicle including a traction motor, a battery, and a passenger cabin, the thermal management system comprising:
a motor circuit for cooling a motor circuit thermal load including the traction motor, the motor circuit including a radiator and a motor circuit pump;
a battery circuit for cooling a battery circuit thermal load including the battery, the battery circuit including a battery circuit pump;
a valve having a first position that allows fluid to flow between the motor circuit and the battery circuit when the battery circuit pump is on and a second position that prevents fluid from flowing between the motor circuit and the battery circuit when the battery circuit pump is on; and
a controller, wherein, when the battery is being charged by an external electrical source the controller is configured to operate the motor circuit pump to preemptively cool the motor circuit thermal load while the valve is in the second position, and to subsequently position the valve in the first position and operate the battery circuit pump to cool the battery circuit thermal load using the radiator.

2. The system of claim 1, further comprising a motor circuit temperature sensor positioned to sense a temperature of fluid in the motor circuit, the controller configured to position the valve in the second position and operate the motor circuit pump according to at least the temperature sensed by the motor circuit temperature sensor when the battery is being charged.

3. The system of claim 2, wherein the controller is configured to position the valve in the second position and operate the motor circuit pump further according to a state of charge of the battery.

4. The system of claim 2, further comprising a battery circuit temperature sensor positioned to sense a temperature of fluid in the battery circuit, the controller configured to position the valve in the second position and operate the motor circuit pump further according to the temperature sensed by the battery circuit temperature sensor.

5. The system of claim 2, further comprising an ambient temperature sensor positioned to detect an ambient temperature, the controller configured to position the valve in the second position and operate the motor circuit pump further according to the temperature sensed by the ambient temperature sensor.

6. The system of claim 1, further comprising a battery circuit temperature sensor positioned to sense a temperature of fluid in the battery circuit, the controller configured to position the valve in the first position and operate the battery circuit pump according to the temperature sensed by the battery circuit temperature sensor.

7. The system of claim 1, further comprising a radiator fan adjacent the radiator, the controller configured to operate the radiator fan when positioning the valve in the first position and operating the battery circuit pump to cool the battery circuit thermal load using the radiator.

8. The system of claim 1, wherein the radiator is the only radiator provided to the electric vehicle.

9. The system of claim 1, wherein the battery circuit further comprises a chiller, the system further comprising a compressor connected to the chiller, the controller further configured to not operate the compressor when positioning the valve in the first position and operating the battery circuit pump to cool the battery circuit thermal load using the radiator.

10. A thermal management system for an electric vehicle, the electric vehicle including a traction motor, a battery, and a passenger cabin, the thermal management system comprising:
a motor circuit for cooling a motor circuit thermal load including the traction motor, the motor circuit including a radiator and a motor circuit pump;
a motor circuit temperature sensor positioned to sense a temperature of fluid in the motor circuit;
a battery circuit for cooling a battery circuit thermal load including the battery, the battery circuit including a battery circuit pump;
a battery circuit temperature sensor positioned to sense a temperature of fluid in the battery circuit;
a valve having a first position that allows fluid to flow between the motor circuit and the battery circuit when the battery circuit pump is on and a second position that prevents fluid from flowing between the motor circuit and the battery circuit when the battery circuit pump is on;
an ambient temperature sensor positioned to detect an ambient temperature; and
a controller, wherein, when the battery is being charged by an external electrical source and the temperature sensed by the motor circuit temperature sensor is above a selected value the controller is configured to operate the motor circuit pump to preemptively cool the motor circuit thermal load with the valve in the second position, and to subsequently position the valve in the first position and operate the battery circuit pump to cool the battery circuit thermal load using the radiator.

11. The system of claim 10, further comprising a radiator fan adjacent the radiator, the controller configured to operate the radiator fan when positioning the valve in the first position and operating the battery circuit pump to cool the battery circuit thermal load using the radiator.

12. The system of claim 10, wherein the radiator is the only radiator included in the thermal management system.

13. The system of claim 10, wherein the battery circuit further comprises a chiller, the system further comprising a compressor connected to the chiller, the controller further configured to not operate the compressor when positioning the valve in the first position and operating the battery circuit pump to cool the battery circuit thermal load using the radiator.

14. A method of cooling a battery of an electric vehicle, the method comprising:
a) when charging the battery using an external electrical source but prior to the temperature of the battery reaching a selected temperature, cooling a motor of the electric vehicle by a selected amount by circulating fluid between the motor and a radiator of the electric vehicle; and
b) after step a) cooling the battery of the electric vehicle by circulating fluid between the battery, the motor and the radiator while charging the battery using the external electrical source.

15. The method of claim 14 further comprising operating a radiator fan when cooling the motor and when cooling the battery.

16. The method of claim 14 further comprising not operating a chiller compressor when cooling the battery.

17. The method of claim 14 further comprising sensing a high temperature of the motor as a condition for cooling the motor and stopping to cool the motor after sensing a temperature of the motor lower than the high temperature and lower than a desired battery temperature of the battery.

18. The method of claim 17 further comprising sensing a temperature of the battery as being above an amount below the desired battery temperature of the battery as a further condition for cooling the motor.

19. The method of claim 17 further comprising sensing an ambient temperature as being lower than the desired battery temperature of the battery as a further condition for cooling the motor.

20. The method of claim 17 further comprising determining a state of charge of the battery as being less than full charge as a further condition for cooling the motor.
